(19) United States
(12) Patent Application Publication
(10) Pub. No.: US 2025/0067891 A1
(43) Pub. Date: Feb. 27, 2025

(54) METHOD OF ATTENUATING MIGRATION ARTIFACTS

(71) Applicant: ARAMCO SERVICES COMPANY, Houston, TX (US)

(72) Inventors: Hong Liang, Houston, TX (US); Houzhu Zhang, Houston, TX (US); Dongliang Zhang, Khobar (SA)

(73) Assignee: ARAMCO SERVICES COMPANY, Houston, TX (US)

(21) Appl. No.: 18/454,614

(22) Filed: Aug. 23, 2023

(51) Int. Cl. G01V 1/50

(52) U.S. Cl. CPC G01V 1/50; G01V 2210/161; G01V 2210/6222

(57) ABSTRACT

Methods and systems are disclosed. The methods may include obtaining vertical seismic profile (VSP) data and a seismic velocity model for a subterranean region of interest and determining, using the seismic velocity model and reverse time migration, a pre-stacked migrated seismic image based on the VSP data. The pre-stacked migrated seismic image includes seismic slices. The methods may further include, for each of the seismic slices in turn, determining a coherency map, determining a weighting map based on the coherency map, and determining a corrected seismic slice by applying the weighting map to each of the seismic slices. The methods may still further include determining a post-stacked corrected migrated seismic image based on the corrected seismic slices and determining a location of a geological feature within the subterranean region of interest based, at least in part, on the post-stacked corrected migrated seismic image.

### BACKGROUND

Seismic processing may be a series of steps designed to alter raw vertical seismic profile (VSP) data collected for a subterranean region of interest that surrounds a wellbore. The processed VSP data, typically in the form of a seismic image, may then be immediately used to locate geological features, such as faults, within the subterranean region of interest that manifest as seismic events within the seismic image.

If the seismic events within the VSP data are manifestations of complex geological features within the subterranean region of interest, the seismic processing step of migration may be performed. Migration may aim to relocate the seismic events within the raw or partially processed VSP data such that the seismic events correspond to the true locations of the complex geological features within the subterranean region of interest.

However, migration may unintentionally generate migration artifacts. The migration artifacts may blur, distort, and/or occlude the seismic events. In turn, blurred, distorted, and/or occluded seismic events may make it difficult to locate geological features within the subterranean region of interest.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method. The method includes obtaining vertical seismic profile (VSP) data and a seismic velocity model for a subterranean region of interest and determining, using the seismic velocity model and reverse time migration, a pre-stacked migrated seismic image of the subterranean region of interest based on the VSP data. The pre-stacked migrated seismic image includes seismic slices. The method further includes, for each of the seismic slices in turn, determining a coherency map, determining a weighting map based on the coherency map, and determining a corrected seismic slice by applying the weighting map to each of the seismic slices. The method still further includes determining a post-stacked corrected migrated seismic image based on the corrected seismic slices and determining a location of a geological feature within the subterranean region of interest based, at least in part, on the post-stacked corrected migrated seismic image.

In general, in one aspect, embodiments relate to a system. The system includes a seismic processing system and a seismic interpretation workstation. The seismic processing system is configured to receive vertical seismic profile (VSP) data and a seismic velocity model for a subterranean region of interest and determine, using the seismic velocity model and reverse time migration, a pre-stacked migrated seismic image of the subterranean region of interest based on the VSP data. The pre-stacked migrated seismic image includes seismic slices. The seismic processing system is further configured to, for each of the seismic slices in turn, determine a coherency map, determine a weighting map based, at least in part, on the coherency map, and determine a corrected seismic slice by applying the weighting map to each of the seismic slices. The seismic processing system is still further configured to determine a post-stacked corrected migrated seismic image based on the corrected seismic slices. The seismic interpretation workstation is configured to determine a location of a geological feature within the subterranean region of interest based, at least in part, on the post-stacked corrected migrated seismic image.

In general, in one aspect, embodiments relate to a non-transitory computer-readable memory having computer-executable instructions stored thereon that, when executed by a computer system, perform steps. The steps include receiving vertical seismic profile (VSP) data and a seismic velocity model for a subterranean region of interest and determining, using the seismic velocity model and reverse time migration, a pre-stacked migrated seismic image of the subterranean region of interest based on the VSP data. The pre-stacked migrated seismic image includes seismic slices. The steps further include, for each of the seismic slices in turn, determining a coherency map, determining a weighting map based, at least in part, on the coherency map, and determining a corrected seismic slice by applying the weighting map to each of the seismic slices. The steps still further include determining a post-stacked corrected migrated seismic image based on the corrected seismic slices and determining a location of a geological feature within the subterranean region of interest based, at least in part, on the post-stacked corrected migrated seismic image.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 illustrates a vertical seismic profile acquisition system in accordance with one or more embodiments.

FIGS. 2A-2E each illustrates seismic waves associated with a gather in accordance with one or more embodiments.

FIGS. 2F-2J each illustrates seismic traces organized into a gather in accordance with one or more embodiments.

FIG. 3 displays a seismic velocity model in accordance with one or more embodiments.

FIG. 4 displays a pre-stacked migrated seismic image in accordance with one or more embodiments.

FIG. 5A displays a seismic slice in accordance with one or more embodiments.

FIG. 5B displays a filtered seismic slice in accordance with one or more embodiments.

FIG. 5C displays a coherency map in accordance with one or more embodiments.

FIG. 5D displays a weighting map in accordance with one or more embodiments.

FIG. 5E displays a corrected seismic slice in accordance with one or more embodiments.

FIG. 6A displays a post-stacked corrected migrated seismic image in accordance with one or more embodiments.

FIG. 6B displays a post-stacked migrated seismic image in accordance with one or more embodiments.

FIG. 7 shows a flowchart in accordance with one or more embodiments.

FIG. 8 shows a flowchart in accordance with one or more embodiments.

FIG. 9 illustrates a computer system in accordance with one or more embodiments.

FIG. 10 illustrates a drilling system in accordance with one or more embodiments.

FIG. 11 illustrates a systems flowchart in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a seismic image” includes reference to one or more of such images.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that the reference character associated with an element implies that the element as displayed in one or more figures is an example of the element and not the only form that the element may take.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

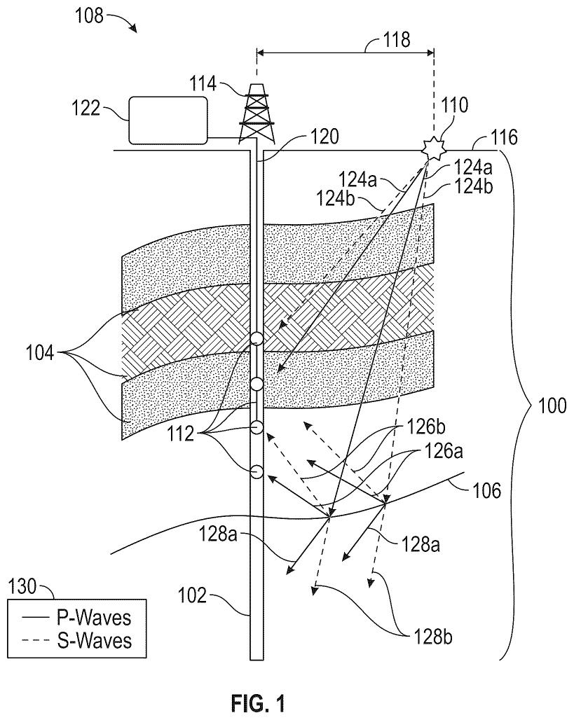

In the following description of FIGS. 1-11, any component described regarding a figure, in various embodiments disclosed herein, may be equivalent to one or more like-named components described regarding any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described regarding a corresponding like-named component in any other figure.

Methods and systems are disclosed to determine a post-stacked corrected migrated seismic image following reverse time migration (RTM) of vertical seismic profile (VSP) data. In some embodiments, the post-stacked corrected migrated seismic image may attenuate migration artifacts caused by RTM. One type of migration artifact is a semicircular, concave-up migration artifact colloquially referred to as a “migration smile” or simply “smile.” In other embodiments, the post-stacked corrected migrated seismic image may attenuate other artifacts not caused by RTM, such as noise.

To obtain the VSP data, a VSP survey may be performed over a subterranean region of interest 100 that surrounds a wellbore 102 as illustrated in FIG. 1. The VSP survey may be performed during and/or following the drilling of at least a portion of the wellbore 102. The drilled wellbore 102 may traverse layers of rock 104 separated by geological boundaries 106. The drilled wellbore 102 may or may not penetrate a hydrocarbon reservoir within the subterranean region of interest 100.

The VSP survey may use a VSP acquisition system 108 configured to obtain the VSP data by radiating, detecting, and recording seismic waves. The VSP acquisition system 108 may include one or more seismic sources 110 configured to radiate the seismic waves. In land operations, the VSP acquisition system 108 may further include multiple seismic receivers 112 configured to detect and record the ground motion caused by the radiated seismic waves.

The VSP acquisition system 108 may be configured to perform one or more types of VSP surveys. Types of VSP surveys may include, but are not limited to, zero-offset VSP surveys, offset VSP surveys, walkaway VSP surveys, walk-above VSP surveys, and seismic-while-drilling VSP surveys. Further, each type of VSP survey may be a two-dimensional or three-dimensional VSP survey. To perform a zero-offset VSP survey, one or more stationary seismic sources 110 may be placed near the drill rig 114 on the surface of the earth 116 and multiple dynamic seismic receivers 112 placed within the wellbore 102 (i.e., downhole). Because the one or more stationary seismic sources 110 are near the drill rig 114, the seismic source offset distance 118 (hereinafter “source offset” or simply “offset”) between the wellbore 102 and each seismic source 110 may be nearly zero. To perform an offset VSP survey, one or more static seismic sources 110 may be placed some offset 118 away from the drill rig 114 on the surface of the earth 116 and multiple dynamic seismic receivers 112 placed downhole within the wellbore 102. To perform a walkaway VSP survey, one or more dynamic seismic sources 110 may be placed on the surface of the earth 116 and multiple stationary seismic receivers 112 placed downhole within the wellbore 102. To perform a walk-above VSP survey, multiple stationary seismic sources 110 may be placed on the surface of the earth 116 and multiple stationary seismic receivers 112 placed downhole within the wellbore 102. The seismic sources 110 are often directly above the seismic receivers 112 in a deviated wellbore (not shown). To perform a seismic-while-drilling VSP survey, a dynamic drill bit drilling the wellbore 102 may act as the seismic source 110 downhole with multiple stationary seismic receivers 112 positioned on the surface of the earth 116. Thus, FIG. 1 may depict multiple types of VSP surveys such as an offset VSP survey or walkaway VSP survey.

Depending on the type of VSP survey performed, either the seismic source(s) 110 or seismic receivers 112 may be suspended downhole within the wellbore 102 using a means of conveyance 120 attached to the drill rig 114. The means of conveyance 120 may be a wireline cable, fiber optic cable, coil tubing, drill pipe, wired drill pipe, or any other conveyance known to a person of ordinary skill in the art. The means of conveyance 120 provides mechanical support for the seismic source(s) 110 or seismic receivers 112 downhole. Further, the means of conveyance 120 may provide electrical power to the seismic source(s) 110 or seismic receivers 112, transmit VSP data recorded by the seismic receivers 112 to a recording facility 122 on the surface of the earth 116, or both. In land operations, the recording facility 122 may be mounted within a truck. In sea operations, the recording facility 122 may be part of the drill rig 114, production platform, or ship.

Once the seismic source(s) 110 and seismic receivers 112 have been positioned to perform a VSP survey, the seismic source(s) 110 may generate radiated seismic waves 124a-b that propagate along of the surface of the earth 116 as surface waves (i.e., ground roll) (not shown) and through the subterranean region of interest 100. Some radiated seismic waves 124a-b may propagate directly through the subterranean region of interest 100. Other radiated seismic waves 124a-b may propagate through the subterranean region of interest 100 and reflect at one or more geological boundaries 106 as reflected seismic waves 126a-b. Still other radiated seismic waves 124a-b may propagate through the subterranean region of interest 100 and refract at one or more geological boundaries 106 as refracted seismic waves 128a-b. Further, some radiated seismic waves 124a-b, reflected seismic waves 126a-b, and refracted seismic waves 128a-b may be compressional waves (124a, 126a, and 128a) (i.e., P-waves) and others may be shear waves (124b, 126b, and 128b) (i.e., S-waves) as shown by the key 130. Further still, reflected and refracted S-waves 126b, 128b may produce both S-waves and P-waves. Similarly, reflected and refracted P-waves 126a, 128a may produce both P-waves and S-waves. Hereinafter, radiated seismic waves 124a-b, surface waves, reflected seismic waves 126a-b, and refracted seismic waves 128a-b may be generically referred to as simply “seismic waves.”

As seismic waves propagate along the surface of the earth 116 and through the subterranean region of interest 100, each seismic receiver 112 may detect and record the ground motion caused by seismic waves over time as a seismic trace. Each seismic trace may represent the amplitude of the ground motion caused by the seismic waves at a sequence of discrete times t beginning after the seismic waves are radiated from the seismic source(s) 110. As such, each seismic trace may be a function of the position of the seismic source 110 from which the seismic waves are radiated, the position of each seismic receiver 112 that detects and records the seismic waves, and time. Hereinafter, the collection of seismic traces recorded during a VSP survey is referred to as “VSP data.” As such, the VSP data may be time-domain VSP data. Further, the VSP data may be regularly and/or densely sampled if, for example, the seismic source(s) 110 are equally positioned relative to one another or moved over equal intervals and the seismic receivers 112 are equally positioned relative to one another.

The collection of seismic traces among the VSP data may be organized into groups such that the seismic traces within each group share one or more common attributes. The seismic traces organized into each group may be referred to as a “gather.” Types of gathers include, but are not limited to, a common shot gather, common receiver gather, common offset gather, common midpoint gather, and common depth point gather. Hereinafter, the generic term “gather” may be used to denote any type of gather. As such, the collection of seismic traces among the VSP data may be organized into gathers.

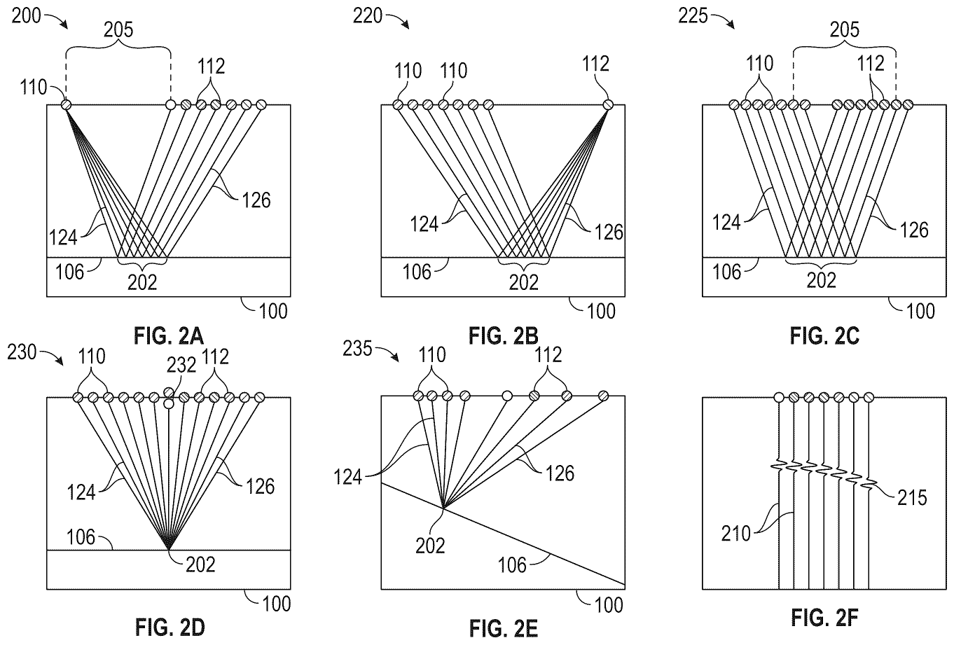

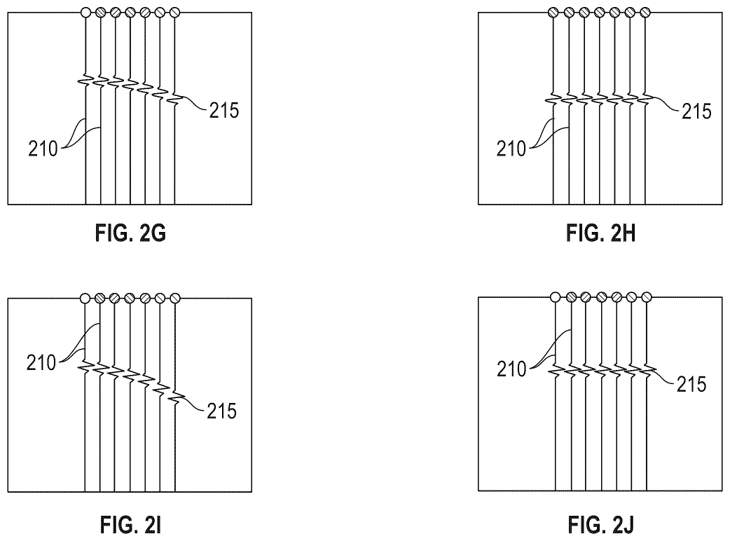

Each of FIGS. 2A-2E illustrates how a collection of seismic waves may propagate through a subterranean region of interest 100 when the associated collection of seismic traces is organized by gather. Each of FIGS. 2F-2J illustrates the associated collection of seismic traces organized by gather. While FIGS. 2A-2E only illustrate radiated seismic waves 124 and reflected seismic waves 126 in two spatial dimensions for clarity, a person of ordinary skill in the art will appreciate that any type of gather may include radiated seismic waves 124, surface waves, reflected seismic waves 126, and/or refracted seismic waves in three spatial dimensions without departing from the scope of the disclosure. Note that the portions of the seismic traces associated with the down-going radiated seismic waves 124 may be referred to as a “down-going wavefield.” Further, the portions of the seismic traces associated with the up-going reflected seismic waves 126 may be referred to as an “up-going wavefield.”

FIG. 2A illustrates a collection of seismic waves associated to a common shot gather 200. In a common shot gather 200, each radiated seismic wave 124 may appear to radiate from a common seismic source 110, reflect at a geological boundary 106 within the subterranean region of interest 100 at one of several points 202 as a reflected seismic wave 126, and be detected and recorded by uncommon seismic receivers 112. Each seismic receiver 112 may be equally offset relative to neighboring seismic receivers 112. Further, each seismic receiver 112 may be offset by an increasing source-receiver offset 205 relative to the seismic source 110. FIG. 2F illustrates a collection of seismic traces 210 that may be recorded for a common shot gather 200. Each seismic trace 210 may be recorded by each seismic receiver 112 illustrated in FIG. 2A. Each seismic trace 210 may indicate the propagation time of a seismic wave radiated from the seismic source 110, reflected at the geological boundary 106, and detected and recorded by one seismic receiver 112. The pulse 215 within each seismic trace 210 may indicate when the seismic waves reflected at the geological boundary 106. Each pulse 215 or a collection of pulses 215 may be referred to as a “seismic event.” As such, a seismic event may be considered a manifestation of a geological feature, such as the geological boundary 106, within the subterranean region of interest 100. In a common shot gather 200, each pulse 215 within each seismic trace 210 may appear at increasing times with increasing source-receiver offsets 205 due to the increasing propagation distance. This phenomenon is known as “moveout.”

FIG. 2B illustrates a collection of seismic waves associated to a common receiver gather 220. In a common receiver gather 220, each radiated seismic wave 124 may appear to radiate from uncommon seismic sources 110, reflect at the geological boundary 106 within the subterranean region of interest 100 at one of several points 202 as a reflected seismic wave 126, and be detected and recorded by a common seismic receiver 112. Each seismic source 110 may be equally offset relative to neighboring seismic sources 110. FIG. 2G illustrates a collection of seismic traces 210 that may be recorded for a common receiver gather 220. Again, each seismic trace 210 may indicate the propagation time of a seismic wave radiated from each seismic source 110, reflected at the geological boundary 106, and detected by the seismic receiver 112. The pulse 215 within each seismic trace 210 may indicate when the seismic waves reflected at the geological boundary 106. In a common receiver gather 220, each pulse 215 within each seismic trace 210 may appear at increasing times due to moveout.

FIG. 2C illustrates a collection of seismic waves associated to a common offset gather 225. In a common offset gather 225, each radiated seismic wave 124 may appear to radiate from uncommon seismic sources 110, reflect at the geological boundary 106 within the subterranean region of interest 100 at one of several points 202 as a reflected seismic wave 126, and be detected and recorded at uncommon seismic receivers 112. Each seismic source 110 may be equally offset from neighboring seismic sources 110. Each seismic receiver 112 may also be equally offset relative to neighboring seismic receivers 112. However, the source-receiver offset 205 between each location of a seismic source 110 and the corresponding location of a seismic receiver 112 is fixed for all seismic traces 210 within the common offset gather 225. FIG. 2H illustrates a collection of seismic traces 210 that may be recorded for a common offset gather 225. Again, each seismic trace 210 may indicate the propagation time of a seismic wave radiated from each seismic source 110, reflected at the geological boundary 106, and detected and recorded by each seismic receiver 112. The pulse 215 within each seismic trace 210 may indicate when the seismic waves reflected at the geological boundary 106. In a common offset gather 225, each pulse 215 within each seismic trace 210 may appear at nearly the same time.

FIG. 2D illustrates a collection of seismic waves associated to a common midpoint gather 230. In a common midpoint gather 230, each radiated seismic wave 124 may appear to radiate from uncommon seismic sources 110, reflect at the geological boundary 106 within the subterranean region of interest 100 at one point 202 (i.e., the common depth point) as a reflected seismic wave 126, and be detected and recorded by uncommon seismic receivers 112. Each seismic source 110 may be equally offset relative to neighboring seismic sources 110. Each seismic receiver 112 may also be equally offset relative to neighboring seismic receivers 112. However, the midpoint location (i.e., the common midpoint 232) between each location of a seismic source 110 and the corresponding location of a seismic receiver 112 is fixed within the common midpoint gather 230. FIG. 2I illustrates a collection of seismic traces 210 that may be recorded for a common midpoint gather 230. As with a common shot gather 200 and common receiver gather 220, each pulse 215 within each seismic trace 210 may appear at increasing times due to moveout.

FIG. 2E illustrates a collection of seismic waves associated to a common depth point gather 235. In a common depth point gather 235, each radiated seismic wave 124 may appear to radiate from an uncommon seismic source 110, reflect at a geological boundary 106 with a dip within the subterranean region of interest 100 at one point 202 (i.e., the common depth point), and be detected and recorded by uncommon seismic receivers 112. Each seismic source 110 may or may not be equally offset relative to neighboring seismic sources 110. FIG. 2J illustrates a collection of seismic traces 210 that may be recorded for a common depth point gather 235. As with a common offset gather 225, each pulse 215 within each seismic trace 210 may appear at nearly the same time.

Turning to FIGS. 2H and 2J, the seismic traces 210 in each may be immediately stacked. Stacking may be the process of adding the seismic traces 210 together to determine a single seismic trace. In turn, the single seismic trace may include a pulse at the same position as each pulse 215 within the seismic traces 210 but with an increased amplitude. As such, the process of stacking seismic traces 210 may enhance the signal-to-noise ratio of the VSP data. Stacking may be considered one step of seismic processing, which is described in detail below.

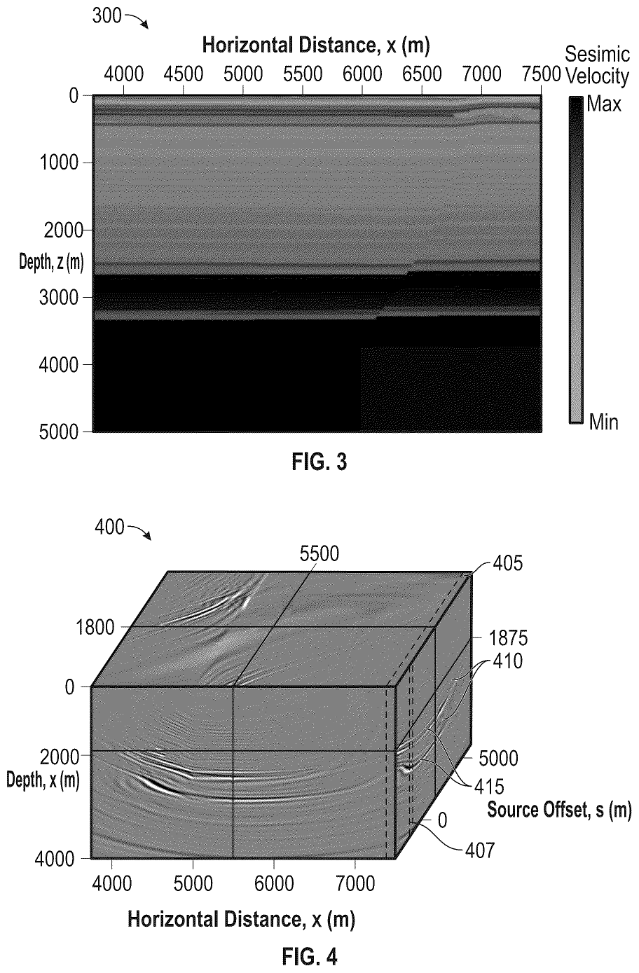

In some embodiments, the VSP data or a portion of the VSP data may be used to determine a seismic velocity model for the subterranean region of interest 100. In other embodiments, a checkshot survey may be performed over the subterranean region of interest 100 surrounding the wellbore 102 and the checkshot data used to determine the seismic velocity model. In some embodiments, the checkshot data may be irregularly and/or sparsely sampled. FIG. 3 displays a seismic velocity model 300 in accordance with one or more embodiments. Here, the seismic velocity model 300 may capture the seismic velocity of the seismic waves at discrete positions across a two-dimensional subterranean region of interest 100 as denoted by horizontal distance x and depth z. As shown by the scale bar, in general, the seismic velocity may increase by depth z.

The VSP data may be used to characterize or further characterize the subterranean region of interest 100. To do so, the VSP data may be processed using a series of steps collectively referred to as seismic processing. The goal of seismic processing may be to produce processed VSP data, typically in the form of a seismic image, that reasonably characterizes the subterranean region of interest 100. Here, characterization may imply that seismic events within the seismic image are manifestations of geological features within the subterranean region of interest 100. One or more seismic processing steps may correct for near-surface effects, suppress noise, correct for VSP survey geometry irregularities, enhance signal-to-noise ratio (e.g., stacking), migrate the seismic events, convert between domains, etc. within the VSP data. Geological features with the subterranean region of interest 100 may then be located by identifying the associated seismic events within the seismic image. Geological features may include, but are not limited to, geological boundaries 106, faults, reefs, and river channel deposits.

The processing step of migration may be applied to the VSP data to relocate one or more seismic events to their true locations. One goal of migration may be to relocate one or more seismic events such that each seismic event corresponds or closely corresponds to the true location of the associated geological feature within the subterranean region of interest 100. In some embodiments, migration may be applied to the VSP data if any of the seismic events are manifestations of a complex geological feature. Hereinafter, processed VSP data that has at least been migrated is referred to as a migrated seismic image.

Various methods of migration may be applied to the VSP data to determine the migrated seismic image. Some methods of migration may be performed before the VSP data is stacked (i.e., pre-stacked). Other methods of migration may be performed after the VSP data is stacked (i.e., post-stacked).

Reverse time migration (RTM), one method of migration, may be applied to the VSP data prior to stacking. As such, RTM may migrate the seismic events within the seismic traces 210 organized into a gather separately from the seismic traces 210 organized into another gather. To migrate the seismic events within the seismic traces 210 organized into a gather, a depth-domain down-going wavefield and depth-domain up-going wavefield may be determined for selected times, such as every millisecond, over a time interval where t=[0, tₘₐₓ]. The time interval may be the same length over which each of the seismic traces were collected. Recall that a down-going wavefield may be associated with the portion of the seismic traces that recorded seismic waves radiating downward from a seismic source 110. Further, recall that an up-going wavefield may be associated with the portion of the seismic traces that recorded seismic waves radiating upward after, for example, reflecting at a geological boundary 106.

The depth-domain down-going wavefield may be determined at all selected times chronologically by solving a one-way or two-way wave equation that uses the seismic velocity model 300, a gather, and boundary conditions, which may be based on the ground motion at the surface of the earth 116 at t=0. If a two-way wave equation is used, the depth-domain down-going wavefield and depth-domain up-going wavefield may both be determined but the depth-domain up-going wavefield may be ignored as it may be considered negligible.

The depth-domain up-going wavefield may be determined for all selected times reverse chronologically by solving a two-way wave equation that uses the seismic velocity model 300, the gather reversed in time, and boundary conditions, which may be based on the ground motion at t>tₘₐₓ.

In some embodiments, the depth-domain down-going wavefield and depth-domain up-going wavefield for each selected time may then be multiplied together and displayed as a seismic slice. However, mathematical operations other than or in addition to multiplication may alternatively be used. Multiplication and other mathematical operations performed at this step in RTM may rely on the idea that the location of a seismic event exists where the first arrival of the depth-domain down-going wavefield is time coincident with the depth-domain up-going wavefield. RTM may be repeated for any, but not necessarily all, of the gathers among the VSP data to determine additional seismic slices or one seismic slice per gather. The concatenation of the seismic slices may be referred to as a pre-stacked migrated seismic image.

FIG. 4 displays a pre-stacked migrated seismic image 400 in accordance with one or more embodiments. The pre-stacked migrated seismic image 400 displayed in FIG. 4 may be determined using the seismic velocity model 300 displayed in FIG. 3 and common shot gathers 200 among the VSP data as described relative to FIGS. 2A and 2F. In FIG. 4, each seismic slice 405 is a function of depth z and source offset s 118. Further, each seismic slice 405 may be a collection of migrated depth-domain seismic traces 407. The seismic slices 405 are concatenated along the horizontal distance x. As such, each of the seismic slices 405 may be referred to as a source-offset domain common-image gather. However, a person of ordinary skill in the art will appreciate that other types of gathers and other domains may be used to define the pre-stacked migrated seismic image 400. Further, a person of ordinary skill in the art will appreciate that FIG. 4 may illustrate a pre-stacked migrated seismic image 400 based on a two-dimensional or three-dimensional VSP survey. If a three-dimensional VSP survey is used, multiple pre-stacked migrated seismic images 400 may be determined. In these embodiments, each pre-stacked migrated seismic image 400 may be associated to an additional parameter, such as an azimuth or additional offset perpendicular to the offset 118 described relative to FIG. 1.

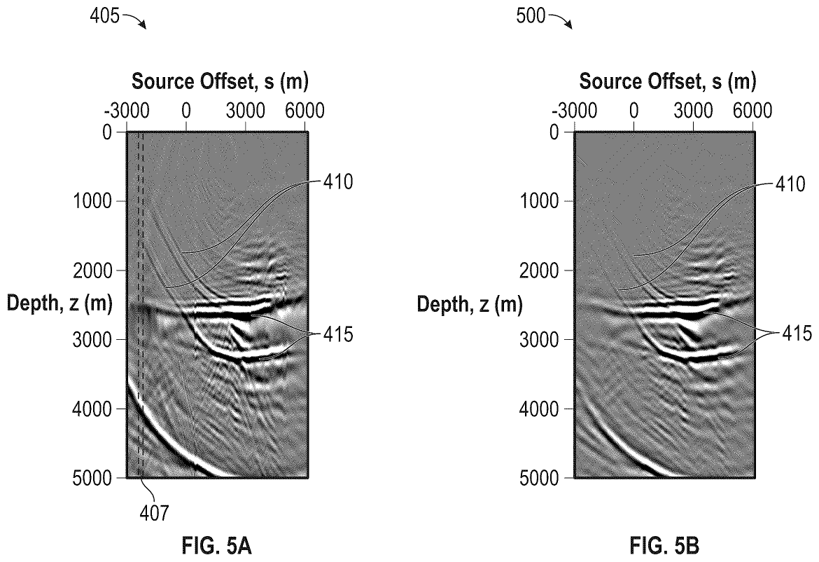

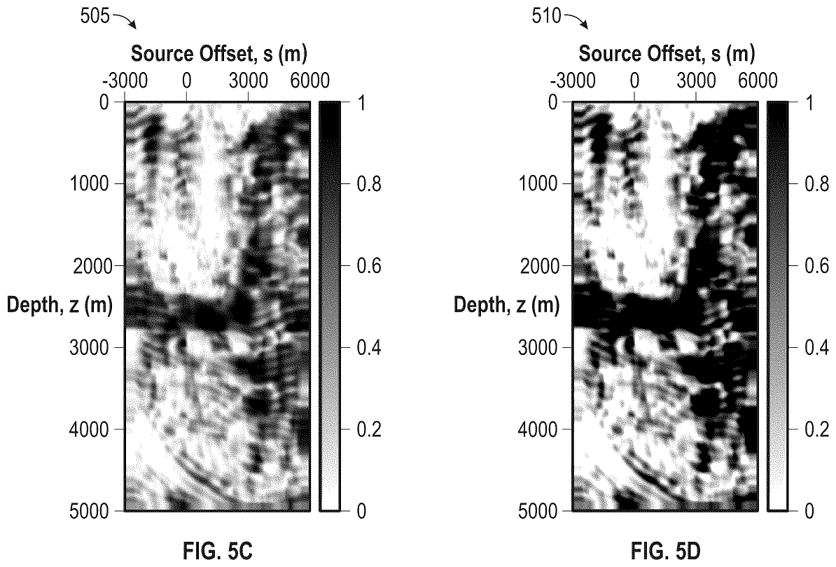

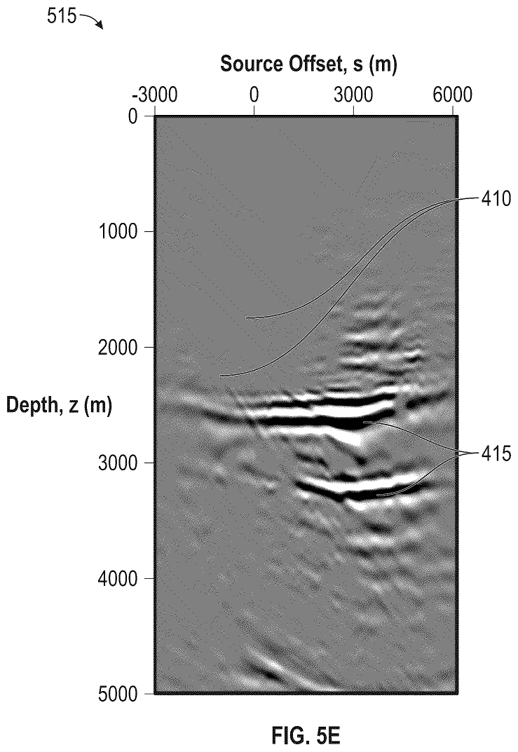

In some embodiments, the pre-stacked migrated seismic image 400 may include migration artifacts caused by RTM. Migration artifacts may include, but are not limited to, migration smiles 410 (hereinafter “smiles”), noise, and other phantom seismic events. Migration artifacts may blur, distort, and/or occlude true seismic events 415 within the pre-stacked migrated seismic image 400. In turn, the location of a geological feature within the subterranean region of interest 100 associated to each true seismic event 415 may be misidentified or may not be identified. For example, FIGS. 4 and 5A display smiles 410 within the pre-stacked migrated seismic image 400 and a seismic slice 405, respectively. Each smile 410 may distort the ends or tails of a true seismic event 415 to appear semicircular and concave up rather than horizontal or nearly horizontal. As such, the location of the geological feature within the subterranean region of interest 100 associated to the true seismic event 415 may be misidentified at locations associated with the tails of each seismic event 415. In other embodiments, the pre-stacked migrated seismic image 400 may include other artifacts not caused by RTM, such as noise. Hereinafter, migration artifacts caused by RTM and other artifacts not caused by RTM are referred to as simply “artifacts.”

The ideas of filtering, coherency, and weighting may be used, at least in part, to attenuate one or more artifacts within each seismic slice 405 of the pre-stacked migrated seismic image 400. To do so, in some embodiments, a transform may be applied to each seismic slice I₁ 405 to determine a spectral seismic slice Ĩ₁. In some embodiments, the transform may be or may include a discrete wavelet transform (DWT) or a dual-tree complex wavelet transform ( [symbol] WT) in one or higher dimensions. In the embodiments where the transform includes a two-dimensional dual-tree [symbol] WT, applying the transform to a seismic slice I₁ 405 may be generically written as:

$${\tilde{I}}_{1} ( z , s , j , o , ri ) = ℂ {WT}_{2 D} ( {I}_{1} ( z , s ) ) , \qquad Equation ( 1 )$$

where j is the scale factor, o is the orientation, and ri is the number type (i.e., real or imaginary).

A filter may then be applied to the spectral seismic slice Ĩ₁ to determine a filtered spectral seismic slice Ĩ₂. In some embodiments, the filter may generically take the form:

$${\tilde{I}}_{2} ( z , s , j , o , ri ) = \{ \begin{matrix}{\tilde{I}}_{1} ( z , s , j , o , ri ) & for selected j and o \\ 0 , & otherwise\end{matrix} \qquad Equation ( 2 )$$

In some embodiments, the filter may attenuate low frequency noise and highly dipping seismic events 415 within the seismic slice I₁ 405.

An inverse transform may then be applied to the filtered spectral seismic slice Ĩ₂ to determine a filtered seismic slice I₂. In some embodiments, the inverse transform may be or may include an inverse [symbol] WT. FIG. 5B displays a filtered seismic slice 500 in accordance with one or more embodiments. The seismic events 415 are maintained and the smiles 410 are attenuated relative to the seismic slice 405 displayed in FIG. 5A.

A coherency map C may then be determined for the filtered seismic slice I₂ 500 or the seismic slice I₁ 405. Coherency may be a measure of similarity between seismic traces 210. Measures of coherency may include, but are not limited to, semblance, cross correlation, and multiple signal classification (MUSIC). In the context of this disclosure, semblance S at each (z, s) position may be defined as the amplitude of the stacked and migrated depth-domain seismic trace of a gather divided by the amplitude of the migrated depth-domain seismic traces 407 that make up the stacked and migrated depth-domain seismic trace. If the migrated depth-domain seismic traces 407 are perfectly coherent at a (z, s) position, S(z, s) equals unity. FIG. 5C displays a coherency map C 505 in accordance with one or more embodiments. FIG. 5C specifically shows a semblance map.

A weighting map w may then be determined based, at least in part, on the coherency map C 505. The weighting map w may adjust the value of the measure of coherency at each (z, s) position within the coherency map C 505 based on a weight function. In some embodiments, the weight function may take the generic form:

$$w ( z , s ) = \{ \begin{matrix}1 , & for C ( z , s ) \geq {c}_{2} \\ \frac{C ( z , s ) - {c}_{1}}{{c}_{2} - {c}_{1}} , & for {c}_{1} \leq C ( z , s ) < {c}_{2} \\ 0 , & for C ( z , s ) < {c}_{1}\end{matrix} \} , \qquad Equation ( 3 )$$

where c₁ and c₂ are threshold values. However, a person of ordinary skill in the art will appreciate that the weight function may rely on more than two threshold values and that the weight function may include other and/or additional functions within each threshold range without departing from the scope of the disclosure. FIG. 5D displays a weighting map w 510 in accordance with one or more embodiments.

A corrected seismic slice I_{1,c} may then be determined by applying the weighting map w 510 to the seismic slice I₁ 405 or filtered seismic slice I₂ 500. In some embodiments, the weighting map w 510 and either the seismic slice I₁ 405 or filtered seismic slice I₂ 500 may be multiplied together to determine the corrected seismic slice I_{1,c}. FIG. 5E displays a corrected seismic slice I_{1,c} 515 in accordance with one or more embodiments. Relative to the seismic slice 405 displayed in FIG. 5A and the filtered seismic slice I₂ 500 in FIG. 5B, the corrected seismic slice 515 maintains the seismic events 415 and attenuates or further attenuates the smiles 410.

This process may be repeated for each seismic slice 405 or each filtered seismic slice I₂ 500 in turn among the pre-stacked migrated seismic image 400.

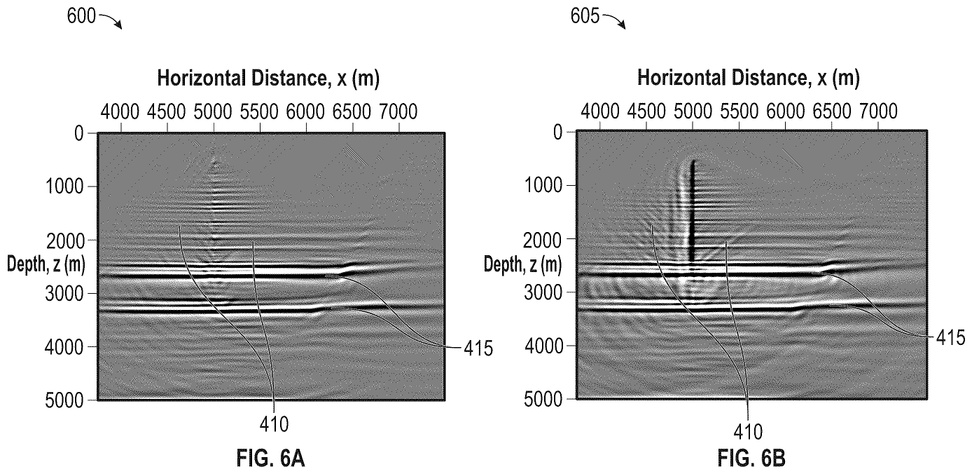

A post-stacked corrected migrated seismic image may then be determined using the corrected seismic slices 515. FIG. 6A displays a post-stacked corrected migrated seismic image 600 in accordance with one or more embodiments. FIG. 6A specifically displays the seismic slices 405 displayed in FIG. 4 corrected following the process described relative to FIGS. 5A-5E and stacked along the source offset s 118. FIG. 6B displays a post-stacked migrated seismic image 605 in accordance with one or more embodiments. FIG. 6B specifically displays the seismic slices 405 displayed in FIG. 4 stacked along the source offset s 118. The seismic slices 405 are not corrected using the process described relative to FIGS. 5A-5E. Upon a comparison of FIGS. 6A and 6B, FIG. 6A clearly displays the seismic events 415 and attenuates the smiles 410.

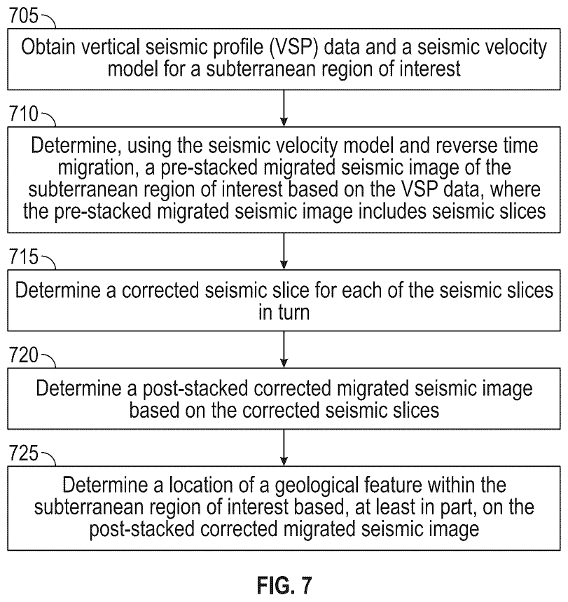

FIG. 7 shows a flowchart in accordance with one or more embodiments. In step 705, VSP data and a seismic velocity model 300 are obtained for a subterranean region of interest 100. The VSP data may be collected using a VSP survey as previously described relative to FIG. 1. In some embodiments, the VSP data or a portion of the VSP data may be used to determine the seismic velocity model 300 for the subterranean region of interest 100. In other embodiments, checkshot data collected using a checkshot survey may be used to determine the seismic velocity model 300 for the subterranean region of interest 100.

In step 710, a pre-stacked migrated seismic image 400 of the subterranean region of interest 100 is determined by applying RTM to the VSP data. RTM may rely, at least in part, on the seismic velocity model 300 to migrate the VSP data one gather at a time as previously described. In some embodiments, other processing steps among seismic processing may be performed on the VSP data before and/or after the VSP data is migrated using RTM. The pre-stacked migrated seismic image 400 includes seismic slices 405.

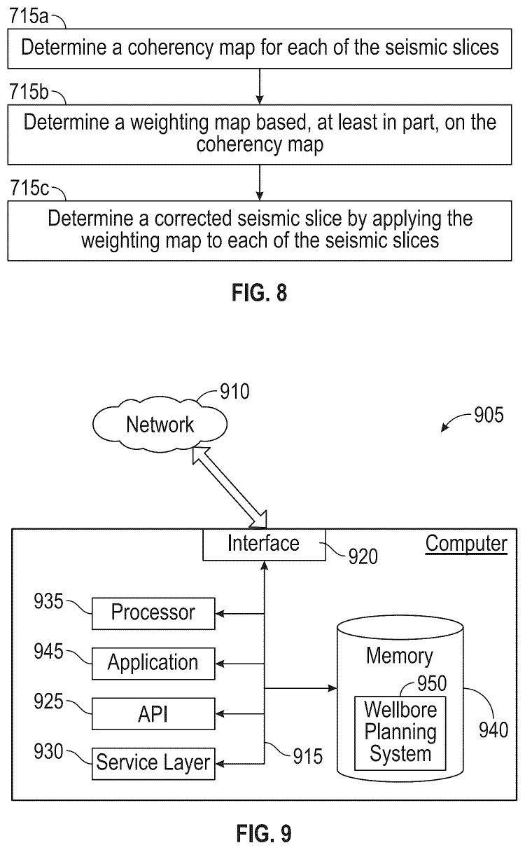

In step 715, a corrected seismic slice 515 is determined for each of the seismic slices 405 in turn. This process is described in detail relative to FIG. 8.

In step 720, a post-stacked corrected migrated seismic image 600 is determined based on the corrected seismic slices 515. In some embodiments, the post-stacked corrected migrated seismic image 600 may be determined by stacking the corrected seismic slices 515 along the source offset s 118.

In step 725, a location of a geological feature within the subterranean region of interest 100 is determined based, at least in part, on the post-stacked corrected migrated seismic image 600. For example, recall that the post-stacked corrected migrated seismic image 600 may include seismic events 415 each of which are manifestations of a geological feature within the subterranean region of interest 100. As such, the post-stacked corrected migrated seismic image 600 may be used to identify the seismic events 415 and, in turn, the corresponding geological features within the subterranean region of interest 100.

A wellbore path may then be planned that penetrates a hydrocarbon reservoir within the subterranean region of interest 100 based, at least in part, on the location of the geological feature within the subterranean region of interest 100. In some embodiments, the previously drilled wellbore 102 used during the VSP survey and/or checkshot survey may not penetrate the hydrocarbon reservoir within the subterranean region of interest 100. In these embodiments, the wellbore path may begin where the previously drilled wellbore 102 ends and end at a target within the hydrocarbon reservoir. In other embodiments, the wellbore path may be a secondary wellbore (i.e., a sidetrack wellbore) that begins at some depth along the depth of the previously drilled wellbore 102 but follows a wellbore path that avoids the location of the geological feature before penetrating the hydrocarbon reservoir within the subterranean region of interest 100. In these embodiments, the geological feature may include, but is not limited to, a fault, reef, and river channel deposit. In some embodiments, the wellbore path may be an offset wellbore path that begins at the surface of the earth 116 and avoids the location of the geological feature before penetrating the hydrocarbon reservoir within the subterranean region of interest 100. A wellbore 102 may then be drilled or continue to be drilled guided by the wellbore path.

FIG. 8 shows a flowchart in accordance with one or more embodiments. Specifically, FIG. 8 describes a method of determining the corrected seismic slice 515 for each of the seismic slices 405 as noted in step 715 in FIG. 7.

In step 715a, a coherency map 505 is determined for each of the seismic slices 405 within the pre-stacked migrated seismic image 400. In some embodiments, each of the seismic slices 405 may be initially filtered. In these embodiments, a spectral seismic slice may be determined by applying a transform to each seismic slice 405. In some embodiments, the transform may be or may include a DWT or a dual-tree [symbol] WT in one or higher dimensions. For example, Equation (1) may be used to determine the spectral seismic slice Ĩ₁. A filtered spectral seismic slice may then be determined by applying a filter to the spectral seismic slice. In some embodiments, the filter may take the form of Equation (2). A filtered seismic slice 500 may then be determined by applying an inverse transform to the filtered spectral seismic slice. In some embodiments, the inverse transform may be or may include an inverse [symbol] WT.

As such, the coherency map 505 may be determined based on each of the seismic slices 405 or each of the filtered seismic slices 500. The coherency map 505 may include a value of a measure of coherency at each (z, s) position within each seismic slice 405 or each filtered seismic slice 500. The measure of coherency may be, but is not limited to, semblance, cross correlation, and MUSIC.

In step 715b, a weighting map 510 is determined based, at least in part, on the coherency map 505. In some embodiments, the weighting map 510 may adjust each value within the coherency map 505 based on a weight function. In some embodiments, the weight function may look similar to Equation (3) where c₁ and c₂ are threshold values.

In step 715c, a corrected seismic slice 515 is determined by applying the weighting map 510 to each of the seismic slices 405 or each of the filtered seismic slices 500. In some embodiments, the weighting map 510 and either the seismic slice 405 or filtered seismic slice 500 may be multiplied together.

Steps 715a-c are repeated for each of the remaining seismic slices 405 or filtered seismic slices 500 in turn.

FIG. 9 illustrates a generic computer system in accordance with one or more embodiments. The computer system (hereinafter also “computer”) may be specifically configured for seismic processing and denoted a “seismic processing system.” For example, steps 705, 710, 715 (including 715a-c), and 720 may be performed by a seismic processing system. Alternatively, the computer 905 may be specifically configured for seismic interpretation and denoted a “seismic interpretation workstation.” For example, step 725 may be performed on a seismic interpretation workstation. While the generic term computer 905 may be used to describe the parts of a computer 905 in the following paragraphs, the terms seismic processing system or seismic interpretation workstation may replace the term computer 905 without departing from the scope of the disclosure.

The computer 905 is intended to depict any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 905 may include an input device, such as a keypad, keyboard, touch screen, or other device that can accept user information, and an output device that displays information, including digital data, visual or audio information (or a combination of both), or a graphical user interface. Specifically, a seismic interpretation workstation may include a robust graphics card for the detailed rendering of a post-stacked corrected migrated seismic image 600 such that the post-stacked corrected migrated seismic image 600 may be displayed and manipulated in a virtual reality system using 3D goggles, a mouse, or a wand to determine a location of a seismic event 415 within the post-stacked corrected migrated seismic image 600 that corresponds to a geological feature within the subterranean region of interest 100.

The computer 905 can serve in a role as a client, network component, server, database, or any other component (or a combination of roles) of a computer system 905 as required for seismic processing and seismic interpretation. The illustrated computer system 905 is communicably coupled with a network 910. For example, a seismic processing system and a seismic interpretation workstation may be communicably coupled using a network 910. In some implementations, one or more components of each computer system 905 may be configured to operate within environments, including cloud-computing-based, local, global, or other environment (or a combination of environments).

At a high level, the computer system 905 is an electronic computing device operable to receive, transmit, process, store, and/or manage data and information associated with seismic processing and seismic interpretation. According to some implementations, the computer system 905 may also include or be communicably coupled with an application server, e-mail server, web server, caching server, streaming data server, business intelligence (BI) server, or other server (or a combination of servers).

Because seismic processing and seismic interpretation may not be sequential, the computer system 905 can receive requests over network 910 from other computer systems 905 or another client application and respond to the received requests by processing the requests appropriately. In addition, requests may also be sent to the computer system 905 from internal users (for example, from a command console or by other appropriate access method), external or third-parties, other automated applications, as well as any other appropriate entities, individuals, systems, or computer systems 905.

Each of the components of the computer system 905 can communicate using a system bus 915. In some implementations, any or all of the components of each computer system 905, both hardware or software (or a combination of hardware and software), may interface with each other or the interface 920 (or a combination of both) over the system bus 915 using an application programming interface (API) 1012 or a service layer 930 (or a combination of the API 925 and service layer 930. The API 925 may include specifications for routines, data structures, and object classes. The API 925 may be either computer-language independent or dependent and refer to a complete interface, a single function, or even a set of APIs. The service layer 930 provides software services to each computer system 905 or other components (whether or not illustrated) that are communicably coupled to each computer system 905.

The functionality of each computer system 905 may be accessible for all service consumers using this service layer 930. Software services, such as those provided by the service layer 930, provide reusable, defined business functionalities through a defined interface. For example, the interface may be software written in JAVA, C++, or other suitable language providing data in extensible markup language (XML) format or another suitable format. While illustrated as an integrated component of each computer system 905, alternative implementations may illustrate the API 925 or the service layer 930 as stand-alone components in relation to other components of each computer system 905 or other components (whether or not illustrated) that are communicably coupled to each computer system 905. Moreover, any or all parts of the API 925 or the service layer 930 may be implemented as child or sub-modules of another software module, enterprise application, or hardware module without departing from the scope of this disclosure.

The computer system 905 includes an interface 920. Although illustrated as a single interface 920 in FIG. 9, two or more interfaces 920 may be used according to particular needs, desires, or particular implementations of each computer system 905. The interface 920 is used by each computer system 905 for communicating with other systems in a distributed environment that are connected to the network 910. Generally, the interface 920 includes logic encoded in software or hardware (or a combination of software and hardware) and operable to communicate with the network 910. More specifically, the interface 920 may include software supporting one or more communication protocols associated with communications such that the network 910 or interface's hardware is operable to communicate physical signals within and outside of the illustrated computer 905.

The computer system 905 includes at least one computer processor 935. Generally, a computer processor 935 executes any instructions, algorithms, methods, functions, processes, flows, and procedures as described in the instant disclosure. A computer processor 935 may be a central processing unit (CPU) and/or a graphics processing unit (GPU). The VSP data may be hundreds of terabytes in size. To efficiently process the VSP data, a seismic processing system may consist of an array of CPUs with one or more subarrays of GPUs attached to each CPU. Further, tape readers or high-capacity hard-drives may be connected to the CPUs using wide-band system buses 915.

The computer system 905 also includes a memory 940 that stores data and software for the computer system 905 or other components (or a combination of both) that can be connected to the network 910. For example, the memory 940 may store a wellbore planning system 950. The wellbore planning system 950 may be used, at least in part, to plan the wellbore path that avoids the location of the geological feature before penetrating the hydrocarbon reservoir within the subterranean region of interest 100. Although illustrated as a single memory 940 in FIG. 9, two or more memories may be used according to particular needs, desires, or particular implementations of the computer system 905 and the described functionality. While memory 940 is illustrated as an integral component of each computer system 905, in alternative implementations, memory 940 can be external to each computer system 905.

The application 945 is an algorithmic software engine providing functionality according to particular needs, desires, or particular implementations of the computer system 905, particularly with respect to functionality described in this disclosure. For example, application 945 can serve as one or more components, modules, applications, etc. Further, although illustrated as a single application 945, the application 945 may be implemented as multiple applications 945 on each computer system 905. In addition, although illustrated as integral to each computer system 905, in alternative implementations, the application 945 can be external to each computer system 905.

There may be any number of computers 905 associated with, or external to, a seismic processing system and a seismic interpretation workstation, where each computer system 905 communicates over network 910. Further, the term “client,” “user,” and other appropriate terminology may be used interchangeably as appropriate without departing from the scope of this disclosure. Moreover, this disclosure contemplates that many users may use the computer system 905, or that one user may use multiple computer systems 905.

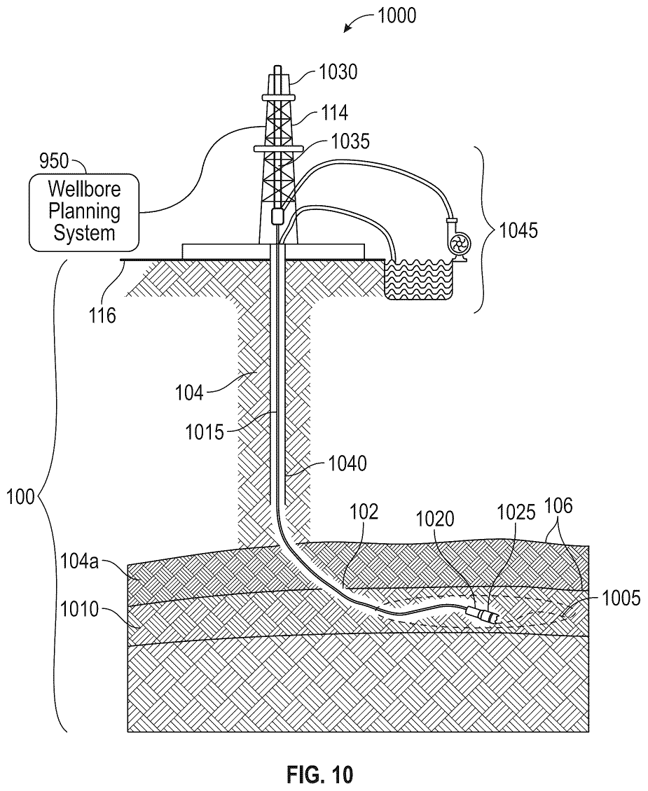

FIG. 10 illustrates a drilling system 1000 in accordance with one or more embodiments. A wellbore 102 may be drilled, using the drilling system 1000, guided by the wellbore path 1005 to penetrate the hydrocarbon reservoir 1010 within the subterranean region of interest 100. Although the drilling system 1000 shown in FIG. 10 is used to drill the wellbore 102 on land, the drilling system 1000 may be a marine wellbore drilling system. Further, although the drilling system 1000 shown in FIG. 10 is used to drill a new wellbore 102, the wellbore 102 being drilled may be a sidetrack wellbore or an offset wellbore. As such, the example of the drilling system 1000 shown in FIG. 10 is not meant to limit the present disclosure.

As shown in FIG. 10, the wellbore 102 may be drilled using a drill rig 114 that may be situated on a land drill site, an offshore platform, such as a jack-up rig, a semi-submersible, or a drill ship. The drill rig 114 may be equipped with a hoisting system, such as a derrick, which can raise or lower the drillstring 1015 and other tools required to drill the wellbore 102. The drillstring 1015 may include one or more drill pipes connected to form conduit and a bottom hole assembly 1020 (BHA) disposed at the distal end of the drillstring 1015. The BHA 1020 may include a drill bit 1025 to cut into rock 104, including cap rock 104a. The BHA 1020 may further include measurement tools, such as a measurement-while-drilling (MWD) tool and logging-while-drilling (LWD) tool. MWD tools may include sensors and hardware to measure downhole drilling parameters, such as the azimuth and inclination of the drill bit 1025, the weight-on-bit, and the torque. The LWD measurements may include sensors, such as resistivity, gamma ray, and neutron density sensors, to characterize the rock 104 surrounding the wellbore 102. Both MWD and LWD measurements may be transmitted to the surface of the earth 116 using any suitable telemetry system known in the art, such as a mud-pulse or by wired-drill pipe.

To start drilling, or “spudding in,” the wellbore 102, the hoisting system lowers the drillstring 1015 suspended from the derrick of the drill rig 114 towards the planned surface location of the wellbore 102. An engine, such as a diesel engine, may be used to supply power to the top drive 1030 to rotate the drillstring 1015 via the drive shaft 1035. The weight of the drillstring 1015 combined with the rotational motion enables the drill bit 1025 to bore the wellbore 102.

The near-surface of the subterranean region of interest 100 is typically made up of loose or soft sediment or rock 104, so large diameter casing 1040 (e.g., “base pipe” or “conductor casing”) is often put in place while drilling to stabilize and isolate the wellbore 102. At the top of the base pipe is the wellhead, which serves to provide pressure control through a series of spools, valves, or adapters (not shown). Once near-surface drilling has begun, water or drill fluid may be used to force the base pipe into place using a pumping system until the wellhead is situated just above the surface of the earth 116.

Drilling may continue without any casing 1040 once deeper or more compact rock 104 is reached. While drilling, a drilling mud system 1045 may pump drilling mud from a mud tank on the surface of the earth 116 through the drill pipe. Drilling mud serves various purposes, including pressure equalization, removal of rock cuttings, and drill bit cooling and lubrication.

At planned depth intervals, drilling may be paused and the drillstring 1015 withdrawn from the wellbore 102. Sections of casing 1040 may be connected, inserted, and cemented into the wellbore 102. Casing string may be cemented in place by pumping cement and mud, separated by a “cementing plug,” from the surface of the earth 116 through the drill pipe. The cementing plug and drilling mud force the cement through the drill pipe and into the annular space between the casing 1040 and the wall of the wellbore 102. Once the cement cures, drilling may recommence. The drilling process is often performed in several stages. Therefore, the drilling and casing cycle may be repeated more than once, depending on the depth of the wellbore 102 and the pressure on the walls of the wellbore 102 from surrounding rock 104.

Due to the high pressures experienced by deep wellbores 102, a blowout preventer (BOP) may be installed at the wellhead to protect the rig and environment from unplanned oil or gas releases. As the wellbore 102 becomes deeper, both successively smaller drill bits 1025 and casing 1040 may be used. Drilling deviated or horizontal wellbores 102 may require specialized drill bits 1025 or drill assemblies.

The drilling system 1000 may be disposed at and communicate with other systems in the wellbore environment. The drilling system 1000 may control at least a portion of a drilling operation by providing controls to various components of the drilling operation. In one or more embodiments, the system may receive data from one or more sensors arranged to measure controllable parameters of the drilling operation. As a non-limiting example, sensors may be arranged to measure weight-on-bit, drill rotational speed (RPM), flow rate of the mud pumps (GPM), and rate of penetration of the drilling operation (ROP). Each sensor may be positioned or configured to measure a desired physical stimulus. Drilling may be considered complete when a drilling target with the hydrocarbon reservoir 1010 is reached or the presence of hydrocarbons is established.

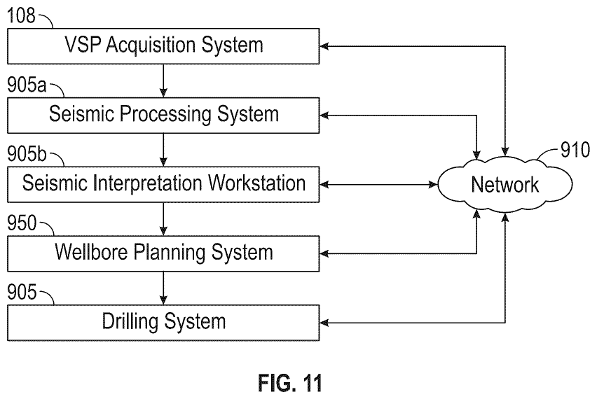

Turning to FIG. 11, FIG. 11 illustrates a systems flowchart in accordance with one or more embodiments. The VSP acquisition system 108 may be configured to obtain the VSP data from a subterranean region of interest 100. The VSP data may be input into and stored on the seismic processing system 905a.

In some embodiments, the seismic processing system 905a may be configured to determine the seismic velocity model 300 from the VSP data or a portion of the VSP data. In other embodiments, the seismic processing system 905a may be configured to determine the seismic velocity model 300 from checkshot data.

The seismic processing system 905a may be configured to perform steps 705, 710. 715 (including 715a-c), and 720 to determine a post-stacked corrected migrated seismic image 600 following RTM of the VSP data as described in FIGS. 7 and 8. In some embodiments, the seismic processing system 905a may perform additional seismic processing steps on the VSP data before, in between, and/or after steps 705, 710, 715 (including 715a-c), and 720 are performed.

The post-stacked corrected migrated seismic image 600 may be transferred to and stored on the seismic interpretation workstation 905b via the network 910 as described relative to FIG. 9. The post-stacked corrected migrated seismic image 600 may then be displayed on the seismic interpretation workstation 905b. In some embodiments, a seismic interpreter may manually manipulate the post-stacked corrected migrated seismic image 600 using the seismic interpretation workstation 905b to determine a location of a geological feature within the subterranean region of interest 100. In some embodiments, the wellbore planning system 950 may be used to plan a wellbore path 1005 that avoids or goes around the location of the geological feature within the subterranean region of interest 100. In some embodiments, the wellbore planning system 950 may be stored on a memory 940 of a generic computer 905, seismic processing system 905a, or seismic interpretation workstation 905b.

The planned wellbore path 1005 may be loaded into the drilling system 1000 discussed in reference to FIG. 10. The drilling system 1000 may be configured to drill the wellbore 102 within the subterranean region of interest 100 guided by the planned wellbore path 1005. The wellbore may be a continuation of the previously partially drilled wellbore 102, a sidetrack wellbore, or an offset wellbore. Following drilling and completion of the wellbore 102, the wellbore 102 may be used to produce hydrocarbons from the hydrocarbon reservoir 1010 to the surface of the earth 116.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method comprising:
obtaining vertical seismic profile (VSP) data and a seismic velocity model for a subterranean region of interest;
determining, using the seismic velocity model and reverse time migration, a pre-stacked migrated seismic image of the subterranean region of interest based on the VSP data,
wherein the pre-stacked migrated seismic image comprises a plurality of seismic slices;
for each of the plurality of seismic slices in turn:
determining a coherency map for each of the plurality of seismic slices,
determining a weighting map based, at least in part, on the coherency map, and
determining a corrected seismic slice by applying the weighting map to each of the plurality of seismic slices;
determining a post-stacked corrected migrated seismic image based on the plurality of corrected seismic slices; and
determining a location of a geological feature within the subterranean region of interest based, at least in part, on the post-stacked corrected migrated seismic image.

2. The method of claim 1, further comprising planning a wellbore path that penetrates a hydrocarbon reservoir within the subterranean region of interest based, at least in part, on the location of the geological feature.

3. The method of claim 2, further comprising drilling a wellbore guided by the wellbore path.

4. The method of claim 1, wherein the VSP data comprises seismic traces organized into a plurality of common shot gathers, and
wherein determining the pre-stacked migrated seismic image comprises applying the reverse time migration to each of the plurality of common shot gathers.

5. The method of claim 1, wherein each of the plurality of seismic slices comprises a plurality of seismic traces organized into a source-offset domain common-image gather.

6. The method of claim 1, wherein determining the coherency map further comprises:
determining a spectral seismic slice by applying a transform to each of the plurality of seismic slices;
determining a filtered spectral seismic slice by applying a filter to the spectral seismic slice; and
determining a filtered seismic slice by applying an inverse transform to the filtered spectral seismic slice.

7. The method of claim 6, wherein the transform comprises a dual-tree complex wavelet transform.

8. The method of claim 6, wherein the filter is a function of a scale factor and orientation.

9. The method of claim 6, wherein the inverse transform comprises an inverse complex wavelet transform.

10. The method of claim 1, wherein the coherency map comprises a value of semblance at each position within each of the plurality of seismic slices.

11. The method of claim 1, wherein determining the weighting map comprises applying a weight function to the coherency map, and
wherein the weight function assigns each value within the coherency map to a group based on a plurality of threshold values.

12. A system comprising:
a seismic processing system configured to:
receive vertical seismic profile (VSP) data and a seismic velocity model for a subterranean region of interest,
determine, using the seismic velocity model and reverse time migration, a pre-stacked migrated seismic image of the subterranean region of interest based on the VSP data,
wherein the pre-stacked migrated seismic image comprises a plurality of seismic slices,
for each of the plurality of seismic slices in turn:
determine a coherency map for each of the plurality of seismic slices;
determine a weighting map based, at least in part, on the coherency map; and
determine a corrected seismic slice by applying the weighting map to each of the plurality of seismic slices, and
determine a post-stacked corrected migrated seismic image based on the plurality of corrected seismic slices; and
a seismic interpretation workstation configured to:
determine a location of a geological feature within the subterranean region of interest based, at least in part, on the post-stacked corrected migrated seismic image.

13. The system of claim 12, further comprising a wellbore planning system configured to plan a wellbore path that penetrates a hydrocarbon reservoir within the subterranean region of interest based, at least in part, on the location of the geological feature.

14. The system of claim 13, further comprising a drilling system configured to drill a wellbore guided by the wellbore path.

15. The system of claim 12, further comprising a VSP acquisition system configured to obtain the VSP data.

16. The system of claim 12, wherein the seismic processing system is further configured to determine the seismic velocity model based, at least in part, on the VSP data.

17. The system of claim 12, wherein the seismic processing system is further configured to:
determine a spectral seismic slice by applying a transform to each of the plurality of seismic slices;
determine a filtered spectral seismic slice by applying a filter to the spectral seismic slice; and
determine a filtered seismic slice by applying an inverse transform to the filtered spectral seismic slice.

18. A non-transitory computer-readable memory having computer-executable instructions stored thereon that, when executed by a computer processor, perform steps comprising:
receiving vertical seismic profile (VSP) data and a seismic velocity model for a subterranean region of interest;
determining, using the seismic velocity model and reverse time migration, a pre-stacked migrated seismic image of the subterranean region of interest based on the VSP data,
wherein the pre-stacked migrated seismic image comprises a plurality of seismic slices;
for each of the plurality of seismic slices:
determining a coherency map for each of the plurality of seismic slices,
determining a weighting map based, at least in part, on the coherency map, and
determining a corrected seismic slice by applying the weighting map to each of the plurality of seismic slices;
determining a post-stacked corrected migrated seismic image based on the plurality of corrected seismic slices; and
determining a location of a geological feature within the subterranean region of interest based, at least in part, on the post-stacked corrected migrated seismic image.

19. The non-transitory computer-readable memory of claim 18, wherein determining the coherency map further comprises:
determining a spectral seismic slice by applying a transform to each of the plurality of seismic slices;
determining a filtered spectral seismic slice by applying a filter to the spectral seismic slice; and
determining a filtered seismic slice by applying an inverse transform to the filtered spectral seismic slice.

20. The non-transitory computer-readable memory of claim 18, wherein determining the weighting map comprises applying a weight function to the coherency map,
wherein the weight function assigns each value within the coherency map to a group based on a plurality of threshold values.
